(19) United States
(12) Patent Application Publication
(10) Pub. No.: US 2007/0218211 A1
(43) Pub. Date: Sep. 20, 2007

(54) Method for protecting pipelines against corrosion

(75) Inventors: Farooq Ahmed, Guelph (CA); Faisal Huda, Toronto (CA); Seraj ul Huda, Toronto (CA); John Barr, Eden Mills (CA)

Correspondence Address: Dennison Associates, Suite 301, 133 Richmond Street West, Toronto, ON, M5H 2L7, CA

(73) Assignee: CSL Silicones Inc.

(21) Appl. No.: 11/375,397

(22) Filed: Mar. 15, 2006

(51) Int. Cl. B05D 3/00; C08L 83/04; B32B 27/00

(52) U.S. Cl. 427/409; 427/387

(57) ABSTRACT

The invention provides for the protection of pipelines and other metal surfaces from corrosion. The metal surface is coated with a vulcanizable elastomeric polyorganosiloxane coating re-inforced with geo-tech fabric or any other similar nature fabric or sheeting materials. In a preferred embodiment the geo-tech re-inforced silicone provides both cathodic and corrosion protection in submersible underground and overground pipelines. The present invention also provides for a method of protecting exposed surfaces particularly metal surfaces more particularly, metal pipelines from the effects of a corrosive environment. The method comprises applying to the surface a thin layer of a vulcanizable elastomeric polyorganosiloxane rubber composition, applying geo-tech or similar fabric onto the wet surface; optionally applying a second application of the same or different vulcanizable elastomeric polyorganosiloxane rubber composition and allowing the composition to cure to a silicone elastomer.

### FIELD OF THE INVENTION

This invention relates to a method of protecting surfaces, particularly pipelines from corrosion and in particular to a method which uses geo-tech or similar fabric and a vulcanizable polyorganosiloxane rubber composition to form a coating on the surface for the corrosion protection of the surface.

### BACKGROUND OF THE INVENTION

A common coating is one which is used to protect metal surfaces against corrosion. Corrosion is an electrochemical process that causes degradation of metal by an oxidative process. Environmental factors such as water, oxygen, salt and acid rain cause oxidative chemical reactions that slowly convert the metal into metal oxide and wear it off from the surface. Coatings provide a barrier between the metal and the environmental factors that cause corrosion. The efficiency of the coating and its service life depends on its barrier properties against penetration of moisture and other chemicals and its resistance to degradation caused by environmental factors such as salt, acid rain and Ultra Violet (UV) radiation. The coating integrity may also be affected by mechanical damage which exposes the metal to the environment and initiates electrochemical oxidation of the metal and subsequent delamination of the coating. Sacrificial metals such as zinc, nickel and aluminum in the coating provide relief against cathodic stress caused by contact of moisture, salt and oxygen to the exposed metal.

In particular, metal surfaces of pipelines exposed to moisture such as rain or fog in combination with contaminated atmospheres as are found in industrial locations may be subject to extensive corrosion unless protected in some way from exposure to the corrosive atmosphere. Other potentially corrosive environments include along sea coasts where salt spray is found and in areas where agricultural chemicals are widely distributed. In addition, metal pipelines directly exposed to water such as in marine or below grade installations are also subject to the potential for extensive corrosion. In the past, such metal surfaces have been most commonly protected by being painted with alkyd based paints. Such paints form a relatively rigid coating on the surface of the metal which can become brittle and when subjected to stress, can flake or chip off, thereby exposing the underlying metal to the corrosive elements. In addition, such paints generally are susceptible to UV damage thereby further reducing their effective life.

Two-part polyorganosiloxane rubber compositions for use as a corrosion protection coating on metals have been developed. For example, Lampe describes in U.S. Pat. No. 4,341,842 a two-part room temperature vulcanizable composition for coating the underside of vehicles to protect the metal from rusting or being corroded by road salts or other similar compounds. However, such two-part compositions have a major disadvantage in that they require the use of complex dual mixing and spray nozzle apparatus or require pre-mixing and immediate use on site when used with conventional spray equipment. If conventional spray equipment is used, the amount of material pre-mixed must also be exact to prevent wastage as the composition has a finite pot life.

Currently pipelines are protected against corrosion with multilayer coating of epoxy/inorganic Zinc (IOZ)/Poly Urethane (PU) and bitumen coating layers. In the case of underground and water submersible pipelines, besides protection against corrosion, the coating itself requires protection against cathodic disbandment. All of the current systems are costly and require periodical maintenance work.

There thus remains a need for a simple to apply coating which provides for protection of pipelines against corrosion for extended periods of time.

### SUMMARY OF THE INVENTION

The present invention provides for the protection of pipelines and other metal surfaces from corrosion. The metal surface is coated with a vulcanizable elastomeric polyorganosiloxane coating re-inforced with geo-tech fabric or any other similar nature fabric or sheeting materials. In a preferred embodiment the geo-tech re-inforced silicone provides both cathodic and corrosion protection in submersible underground and overground pipelines.

In an aspect of the invention, the vulcanizable polyorganosiloxane composition comprises:
a) from about 5 to about 80 weight percent of one or more polyorganosiloxane fluids of the formula:
   R¹[(R)₂SiO]n(R)₂Si R¹
   in which R is a monovalent alkyl or alkenyl radical having 1 to 8 carbon atoms or a phenyl radical, R¹ each of which may be the same or different are OH, a monovalent alkyl or alkenyl radical having 1 to 8 carbon atoms or a phenyl radical, and n has an average value such that the viscosity is from about 10 to about 100,000 centipoise at 25° C. preferably from about 500 to about 20,000 centipoise at 25° C. In at least one of polyorganosiloxane fluids the R¹ is a reactive group such as OH or alkenyl, preferably OH, most preferably both R¹ are OH.
b) from about 10 to about 80 weight percent of a sacrificial metal filler;
c) from about 0 to about 15 weight percent of a conductive filler;
d) a suitable catalyst for the reactive group of the polyorganosiloxane of (a); and
e) a suitable cross linking agent for the reactive group of the polyorganosiloxane of (a).

In another aspect of the invention, the geo-tech or other fabric is impregnated and coated with a room temperature vulcanizable (RTV) polyorganosiloxane composition comprising:
a) about 5 to 60 weight percent of polydimethyl siloxane fluid of the formula:
   HO[(R¹⁴)₂SiO]ₙ(R¹⁴)₂SiOH
   in which R¹⁴ is an alkyl or alkenyl radical having 1 to 8 carbon atoms or a phenyl radical which may contain 3 to 9 halogen atoms, and has an average value such that the viscosity is in the range from 10 to 100,000 centipoise at 25° C., preferably from 500 to 20,000 centipoise at 25° C.;
b) about 0 to 80 weight percent of one or more fillers;
c) about 0.1 to 35 weight percent of one or more oximino silane cross linking or chain extending;
d) about 0.2 to 3 weight percent of an adhesion promoter;
e) about 0.05 to 5 weight percent of a catalyst; and
f) about 0 to 40 weight percent of a suitable solvent or diluent as a dispersion medium for the above composition.

The present invention also provides for a method of protecting exposed surfaces particularly metal surfaces more particularly, metal pipelines from the effects of a corrosive environment. The method comprises applying to the surface a thin layer of a vulcanizable elastomeric polyorganosiloxane rubber composition, applying geo-tech or similar fabric onto the wet surface; optionally applying a second application of the same or a different vulcanizable elastomeric polyorganosiloxane rubber composition and allowing the composition to cure to a silicone elastomer.

### DETAILED DESCRIPTION OF THE INVENTION

The present invention provides for a method for coating surfaces, particularly metal and concrete surfaces, more particularly metal pipelines to protect them against corrosion. The method comprises applying a vulcanizable elastomeric polyorganosiloxane coating reinforced with geo-tech fabric or any other similar fabric or sheeting materials to the surface to be protected. Preferably, the reinforced silicone provides cathodic and corrosion protection, particularly in submersible, underground, and overground pipelines.

The composition utilized in the present invention comprises a vulcanizable polyorganosiloxane along with suitable additives, depending upon the nature of the surface to be protected and the environment to which it is exposed. For example, for metal pipelines, the composition preferably includes a sacrificial metal filler which provides the composition with corrosion protection particularly against cathodic stress.

The composition utilized in the present invention preferably comprises a vulcanizable polyorganosiloxane and a sacrificial metal filler which provides the composition with its corrosion protection particularly against cathodic stress.

The vulcanizable polyorganosiloxane may be any of the commonly utilized vulcanizing polyorganosiloxane compositions utilizing one part or two part systems cured catalytically, for example through addition curing, heat curing or utilizing moisture curing systems. The polyorganosiloxane is terminated with a reactive group, generally hydroxyl or alkenyl as follows:
R¹[(R)₂SiO]n(R)₂Si R¹

in which R is a monovalent alkyl or alkenyl radical having 1 to 8 carbon atoms or a phenyl radical which may contain 3 to 9 halogen atoms, R¹ each of which may be the same or different is a reactive group selected from OH, or a monovalent alkenyl radical having 1 to 8 carbon atoms, and n has an average value such that the viscosity is from about 10 to about 100,000 centipoise at 25° C. preferably from about 500 to about 20,000 centipoise at 25° C.

Catalytically polymerizable polyorganosiloxane compositions using addition cure systems are not controlled by moisture of the atmosphere. High temperature can accelerate the curing process although the crosslinking addition reaction may also occur at room temperature. The base polymer is generally a polydiorganosiloxane of general formula:
R³[(R²)₂SiO]n(R²)₂Si R³

where R² is a monovalent alkyl or alkenyl radical having 1 to 8 carbon atoms, optionally substituted with 1 to 9 halogen atoms, or a phenyl radical, optionally substituted with 1 to 6 halogen atoms, R³ is monovalent alkenyl radical (preferably a monovalent vinyl or ethylene radical) and n has an average value such that the viscosity is from 10 to 100,000 centipoise. An example of such a base polymer is:
CH₂═CH—Si(CH₃)₂—O—Si(CH₃)₂—O - - - O—Si(CH₃)₂—CH═CH₂

The addition cure systems utilize a crosslinker to polymerize the base polymer. The crosslinker is generally a polydiorganosiloxane of general formula:
R⁵[(R⁴)(H)SiO]ₘ[(R⁴)₂SiO]ₙR⁵

where each R⁴ and R⁵ which may be the same or different is a monovalent alkyl or alkenyl radical having 1 to 8 carbon atoms, optionally substituted with 1 to 9 halogen atoms, or phenyl radical, optionally substituted with 1 to 6 halogen atoms and H is hydride radical, m and n are integers and their total average value is such that the viscosity is from 10 to 10,000 centipoise. The value of m is 10 to 50 percent of the value of m+n.

For optimum crosslinking the ratio of the alkenyl radical, preferably ethylene radical, to hydride radical is from 1:1 to 6:1.

The crosslinking reaction of addition cure systems requires a catalyst, generally an organometallic complex of Platinum of the formula:
Pt[R⁷(SiOR⁶)R⁷]₄

In which R⁶ is alkyl or alkenyl and R⁷ is alkenyl. An example of such a platinum catalyst is:
Platinum Divinyltetramethyldisiloxane complex
   (CH₂═CH—Si(CH₃)₂—O—Si(CH₃)₂—CH═CH₂)₄Pt

Crosslinking by addition is an extremely fast reaction. The reaction speed can be controlled by reducing the amount of catalyst or by using a reaction inhibitor such as a vinyl terminated dimethylsiloxane that reduces the activity of the platinum catalyst.

An adhesion promoter may also be used for two-part addition cure system to improve the adhesion of the elastomer to the surface. The adhesion promoter is generally a silane having general formula:
R⁸Si(R⁹O)₃

where R⁸ is an alkenyl radical, preferably a vinyl radical, and R⁹ is an alkyl radical having 1 to 6 carbon atoms.

Addition cure systems are generally provided in two-parts with the base polymer, crosslinker, adhesion promoter and inhibitor in one part and base polymer and catalyst in the other part. Fillers and pigment are added in either part to achieve equivalent viscosity of both parts for homogenous mixing.

Crosslinking of polyorganosiloxane terminated by alkenyl radical such as vinyl radical (also described for addition cure system) can also be accelerated by heat in presence of organic peroxide such as dichlorobenzoyl peroxide, trichlorobenzoyl peroxide or dicumyl peroxide as catalyst. Crosslinking by organic peroxide does not require hydride functional crosslinker (as described in addition cure system).

Moisture curing systems are generally room temperature vulcanizable (RTV), although higher temperatures may be employed to accelerate the curing reaction. The moisture curing composition may be provided as a two part system similar to the addition cure compositions or may be a one part composition containing all of the components of the composition in a single container. Preferably for ease of handling and application, the RTV compositions are in one part.

Moisture cure systems generally utilize a hydroxyl terminated polyorganosiloxane as a base polymer. Preferably, the base polymer is one or more polyorganosiloxanes of the general formula:
R¹¹[(R¹⁰)₂SiO]n(R¹⁰)₂SiR¹¹

in which R¹⁰ is a monovalent alkyl or alkenyl radical having 1 to 8 carbon atoms or a phenyl radical, which may contain 3 to 9 halogen atoms, R¹¹ each of which may be the same or different are OH, a monovalent alkyl or alkenyl radical having 1 to 8 carbon atoms or a phenyl radical, and n has an average value such that the viscosity is from about 10 to about 100,000 centipoise at 25° C. preferably from about 500 to about 20,000 centipoise at 25° C. At least one of the R¹¹ has a reactive group such as OH or alkenyl, preferably OH, most preferably both R¹¹ are OH.

The moisture curing systems utilize a crosslinker having the general formula:
(X)₄₋ₘ—Si—R¹²ₘ

where R¹² is an alkyl, alkenyl or phenyl radical (preferably methyl or ethyl) and X an alkyl radical with a functional group linked directly to silicone atom and m is an integer of from 0 to 2. The functional group can be carboxyl, ketoximino, alkoxy, carbonyl or amine.

The commonly employed cross linkers for moisture cure RTV One-Part or Two-Part Systems include:

Acetoxy Silane (CH₃C(O)O)₃—Si—R¹² Releases Acetic Acid as curing by-product.

Oxime Silane (C₂H₅(CH₃)C═NO)₃—Si—R¹² Releases methylethyl ketoxime as curing by-product.

Alkoxy Silane (R¹³O)₃—Si—R¹² Where R¹³ is an alkyl radical from 1 to 6 carbon. It releases alcohol as curing by-product.

Enoxy Silane (CH₃C(O)CH₂)₃—Si—R¹² Releases Acetone as curing by-product.

Amine Silane ((CH₃)₂N)₃—Si—R¹² Releases Amine as curing by-product. It is the fastest reacting crosslinker that does not require a catalyst.

To improve the crosslinking reaction, a catalyst is generally utilized. For moisture cure systems, one commonly employed catalyst is an organotin salt such as dibutyl tin dilaurate, among others.

To improve the adhesion of the elastomer to the surface on which it is coated, an adhesion promoter may be employed. The adhesion promotor is commonly a compound of the formula:

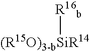

in which R¹⁵ and R¹⁶ are independently selected from monovalent alkyl or alkenyl radicals having 1 to 8 carbon atoms or a phenyl radical which may optionally be substituted with an alkyl radical having 1 to 8 carbon atoms, b is an integer between 0 and 3, and R¹⁴ is a saturated, unsaturated or aromatic hydrocarbon radical having 1 to 10 carbon atoms which may optionally contain a functional group.

The one-part polyorganosiloxane rubber compositions of the present invention for use as a protective coating contain about 5 to about 80 weight percent of one or more polydiorganosiloxane fluids of the formula:
HO[(R¹⁷)₂SiO]ₙ(R¹⁷)₂SiOH

in which R¹⁷ is a monovalent alkyl or alkenyl radical having 1 to 8 carbon atoms or a phenyl radical which may contain 3 to 9 halogen atoms, and n has an average value such that the viscosity is from about 10 to about 100,000 centipoise at 25° C. Preferably n has an average value such that the viscosity is between about 500 and about 20,000 centipoise at 25° C., more preferably between about 1,000 and about 20,000 centipoise at 25° C.

Polydimethylsiloxane is the most preferred silicone polymer fluid. The polydimethylsiloxanes may contain small amounts of monomethylsiloxane units and methyl radical replaced with other radicals in small amounts as impurities such as is found in commercial products, but the preferred fluid contains only polydimethylsiloxane. When using low viscosity fluids, generally 1,000 centipoise or less, it may be advantageous to add bifunctional chain extenders of the general formula:
R¹⁸₂—Si—X¹₂

where X¹ is an alkyl radical with a functional group linked directly to the silicon atom, preferably alkoxyl, ketoximino, carbonyl, carboxyl or amine, most preferably alkoxy or ketoximino and R¹⁸ is a monovalent alkyl or alkenyl radical having 1 to 8 carbon atoms or a phenyl radical. If chain extenders are utilized they are generally present in an amount of up to about 8 weight percent, preferably between about 2 weight percent and about 8 weight percent.

The composition of this preferred embodiment may contain a second linear dimethyl polysiloxane of low molecular weight to act as a viscosity reducer diluent for the composition for ease in applying the composition to the surface. The low molecular weight linear dimethyl polysiloxanes are end blocked oligomeric compounds of the above formula where the terminal —OH are replaced by blocking groups which may be the same or different, are independently selected from a monovalent alkyl or alkenyl radical having 1 to 8 carbon atoms or phenyl radical. The average value of n ranges between 4 and 24, preferably between 4 and 20.

If the composition contains the two different polyorganosiloxanes set out above, the total of the polyorganosiloxanes is generally about 40 to 60 weight percent with the relative amounts of the two polyorganosiloxanes being selected based upon the desired characteristics of the final coating. Generally each of the polyorganosiloxanes will be present in a ratio of from about 30 weight percent to about 70 weight percent based upon the total weight of the polyorganosiloxane fluids.

In addition to, or in place of the low molecular weight linear dimethyl polysiloxanes, the composition may contain up to about 40 weight percent, more preferably 20 to 30 weight percent of a cyclo-organosiloxane of the formula:
[(R¹⁹)₂SiO]n

in which R¹⁹ is a monovalent alkyl or alkenyl radical having 1 to 8 carbon atoms or a phenyl radical which may optionally be substituted with an alkyl radical having 1 to 8 carbon atoms and n has an average value of 3 to 10.

The preferred cycloorganosiloxane is a cyclic dimethylsiloxane and is used in a similar manner to the low molecular weight linear dimethyl polysiloxanes as a diluent to lower the viscosity of the composition for convenient application by spraying, brushing or dipping.

The composition may contain up to 80 weight percent of one or more fillers. The fillers may be functional fillers to increase the resistance of the coating to environmental effects, sacrificial metal fillers to increase the resistance of the coating to cathodic stress from environmental effects, conducting fillers, extending or non-reinforcing fillers and reinforcing fillers to provide for increased strength of the coating.

The composition preferably contains 10 to 80 weight percent, more preferably 30 to 60 weight percent, most preferably 40 to 50 weight percent, of sacrificial metal fillers to increase the resistance of the coating to cathodic stress from environmental effects. The sacrificial metal fillers are preferably selected from zinc powder, zinc flakes, aluminum powder, aluminum flakes, nickel powder, nickel flakes, magnesium powder, and magnesium flakes. The conductive fillers are preferably selected from metal coated glass fibres or powder and mica. Optionally, the formulation may include other inorganic extending or non-reinforcing fillers depending upon the nature of the surface and environment wherein the coating is to be used. The extending fillers are preferably selected from inorganic materials such as calcium carbonate, barium sulfate, iron oxide, diatomaceous earth, quartz, crystalline silica, titanium dioxide, zinc oxide, zirconium oxide, zirconium silicate, zinc borate and chromic oxide. The selection of the filler will be based upon the required properties and the final usage of the composition. For applications where high temperature stability is required a preferred additional filler will be melamine, iron oxide, zinc oxide, titanium dioxide, zirconium oxide, zinc borate or chromic oxide. For coatings requiring higher strength crystalline silica is utilized.

The composition may also contain about 0 to 20 weight percent of an amorphous SiO₂ reinforcing filler having a surface area of between about 50 and about 250 m²/g and a particle size range between about 0.01 and 0.03 microns. Preferably the surface area is between about 50 and about 150 m²/g, more preferably between about 75 and about 150 m²/g. The specific gravity of the filler is preferably about 2.2. The surface of the amorphous silica may also be treated with organic molecules such as hexamethyldisilazane or polydimethylsiloxane or silane. It has been found that using a surface treated silica helps reduce the viscosity of the composition. Similarly the use of lower surface area fillers also aids in reducing viscosity of the composition.

The composition also contains about 0.1 to about 35 weight percent, preferably about 3 to about 15 weight percent, more preferably about 3 to about 10 weight percent of an organofunctional cross-linking agent of general formula:
(X)₄₋ₘ—Si—R¹²ₘ

where R¹² is an alkyl, alkenyl or phenyl radical (preferably methyl or ethyl), X is an alkyl radical with a functional group selected from carboxyl, ketoximino, alkoxy, carbonyl or amine linked directly to the silicone atom, and m is an integer of from 0 to 2. Preferably the cross linking agent is an oximinosilane cross linking agent of the formula R²⁰Si(ON═CR²¹₂)₃ in which R²⁰ and R²¹ each represent a monovalent alkyl or alkenyl radical having 1 to 8 carbon atoms or a phenyl radical, preferably an alkyl radical such as methyl, ethyl, propyl, butyl, or an alkenyl radical such as vinyl, allyl, or a phenyl radical. The preferred R²⁰ and R²¹ are alkyl or vinyl radicals, most preferably methyl and ethyl radicals.

The composition also contains about 0.2 to about 3 weight percent of an organo functional silane as an adhesion promoter. Preferably the organo functional silane has the formula:

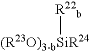

wherein R²² and R²³ are independently selected from monovalent alkyl or alkenyl radicals being 1 to 8 carbon atoms or a phenyl radical which optionally may be substituted with alkyl radicals having 1 to 8 carbon atoms and contain 3 to 9 halogen atoms, b is an integer from 0 to 3, preferably 0, and R²⁴ is a saturated, unsaturated or aromatic hydrocarbon radical being 1 to 10 carbon atoms, which may be further functionalized by a member selected from the group consisting of amino, ether, epoxy, isocyanate, cyano, acryloxy and acyloxy and combinations thereof. R²² and R²³ are preferably an alkyl radical such as, for example, methyl, ethyl, propyl, butyl, or an alkenyl radical such as vinyl and allyl. More preferably R²² and R²³ are alkyl radicals, most preferably methyl, ethyl or propyl radicals. Preferably R²⁴ is an alkyl group, more preferably further functionalized by one or more amino groups. The most preferred organo-functional silane is N-(2-aminoethyl-3-aminopropyl)trimethoxysilane.

The composition additionally contains from about 0 to about 5 weight percent of an organometalic complex as a condensation catalyst which accelerates the aging of the composition. The condensation catalyst is of the formula:
(R²⁵)₂M(R²⁶)₂

where R²⁵ is monovalent alkyl or alkenyl radical having 1 to 10 carbon atoms or a phenyl radical, R²⁶ is an alkyl or alkenyl radical having 1 to 10 carbon or a phenyl radical having an organo-functional group and M is a metal. Preferably the organometalic complex is an organotin complex of a carboxylic acid selected from the group consisting of dibutyltindiacetate, stannous octoate, dibutyltin dioctoate and dibutyltin dilaurate. Preferably the condensation catalyst is present from about 0.02 to about 3 weight percent. Most preferably the organotin salt is dibutyltin dilaurate of the formula:
(C₄H₉)₂Sn(OCOC₁₀H₂₀CH₃)₂.

In all of the above compounds, the alkyl includes straight, branched or cyclic radicals. Among the alkyl groups are C₁₋₁₀ straight or branched-chain alkyl such as, for example, methyl, ethyl, propyl, isopropyl, n-butyl, isobutyl, tert-butyl, pentyl, isopentyl, hexyl, etc., the cycloalkyl are C₃₋₈ cycloalkyl such as, for example, cyclopropyl, cyclobutyl, cyclohexyl, etc., the alkenyl groups are C₁₋₁₀ alkenyl such as, for example, vinyl and allyl. The above groups as well as the phenyl radicals may be further functionalized by including in the chain or ring structure, as the case may be, a group selected from the class consisting of amino, ether, epoxy, isocyanate, cyano, acryloxy, acyloxy and combinations, so long as the functionalization does not adversely affect the desired properties of the compound.

The composition may contain up to about 40, perferably about 10 to 40 weight percent of a suitable solvent or diluent as a dispersion medium. Preferably the solvent or diluent is a hydrocarbon solvent used as a dispersion medium for the composition. The hydrocarbon solvent, if present, is preferably a petroleum based solvent such as naphtha or mineral spirits.

The composition may contain other optional ingredients such as pigments and other fillers in minor amounts provided that the addition of the ingredients does not cause degradation of the corrosion resistance of the cured coating made from the composition. One commonly utilized optional ingredient is a pigment, preferably a grey pigment, most preferably present in amounts up to about 1 weight percent.

The polyorganosiloxane composition of the present invention are prepared by mixing the ingredients together in a conventional manner. For example, the moisture cure polyorganosiloxane composition of the present invention is prepared by mixing the ingredients together in the absence of moisture. The silane is moisture sensitive and will undergo cross-linking in the presence of moisture such that the mixture must be essentially absent of free moisture when the silane is added and maintained in a moisture free state until cure is desired.

A preferred method of mixing comprises mixing the polyorganosiloxane polymer with the reinforcing fillers and other optional fillers and pigments. Thereafter, the oximinosilane and organo functional silane are added and mixed under a nitrogen atmosphere. The solvent is added to the mixture under a nitrogen atmosphere and finally, the organotin salt is added to the mixture. The mixture is then dispensed in the sealed containers for storage prior to use.

The surface of the metal to be protected is coated with the composition by conventional methods such as dipping, brushing or spraying. Preferably, the metal to be protected is coated by spraying an application of the composition of the present invention. The coating generally has an average thickness of 0.25 to 1.50 mm, single or more preferably, an average thickness of 0.5 to 1.0 mm, most preferably about 0.5 to 0.75 mm. After the coating is formed on the surface of the metal, the metal is wrapped spirally or circumferentially with a pre-cut sheet of geo-tech or similar fabric and then exposed to normal atmosphere for cross-linking and cure of the coating. Thereafter a second coating of the same or different composition may be applied and allowed to cure.

The improved coating of the present invention is capable of protecting metal pipelines from corrosion in the presence of moisture such as rain or fog in combination with contaminated atmospheres, salt spray or fog or direct exposure to salt water.

The improved coating method of the present invention is particularly useful for protecting metal pipelines which are directly exposed to water or are buried underground.

The following examples are included to illustrate preferred embodiments of the invention and to demonstrate the usefulness of the coating and are not intended to limit in any way the scope of protection for the invention.

### EXAMPLE 1

A coating composition was prepared by mixing 24 parts by weight of polydimethylsiloxane fluid having viscosity of 5,000 centipoise and 2 parts by weight of surface treated amorphous silica having surface treatment with hexamethyldisilazane and surface area of about 125 m²/g, 10 parts by weight of metal coated glass fibres. Then 3 parts by weight of methyl tris-(methyl ethyl ketoxime) silane and 1 part by weight of N-(2-aminoethyl-3-aminopropyl)trimethoxy silane are added and mixed under nitrogen atmosphere. Then 50 parts by weight of zinc powder were also added and mixed. The coating composition was diluted 10 parts by weight of petroleum naphtha to achieve a viscosity between 3,000 and 4,000 cP. Cured elastomeric coating provides excellent resistance against chemicals, galvanic corrosion, cathodic stress and cathodic delamination.

### EXAMPLE 2

A second coating composition was prepared by mixing 36 parts of dimethyl polysiloxane fluid having a viscosity of 16,750 centipoise at 25° C. with 35 parts of a mixture of amorphous and crystalline silica fillers having a specific gravity of 2.2 and surface area of about 130 m²/g. Then 2 parts of pigment is added and the composition is mixed in a mixer to a uniform consistency. Then 3 parts of methyl tris-(methyl ethyl ketoxime) silane and 1 part of N-(2-aminoethyl-3 aminopropyl)trimethoxysilane are added and mixed under a nitrogen atmosphere. Then 23 parts of naphtha solvent is added to the mixture. Finally, 0.1 part of dibutyltin dilaurate is added to the dispersion and mixed until a uniform consistency is achieved.

A metal pipe was first degreased to thoroughly remove all scale and any trace of lubricants, then hydro blasted. In case of well weathered old pipe, it is thoroughly cleaned by high pressure hydro blast. The wet surface of the pipe was then hot air blow dried. The composition of Example 1 or 2, preferably Example 1, is sprayed on to the entire external surface of the pipe with a wet film thickness (WFT) of approximately 0.7 mm. Immediately after the spray, a pre-cut sheet of geo-tech fabric is spirally or circumferentially wrapped firmly on the wet coating on the pipe. The geo-tech fabric is preferably about 135 gr/m² specification and the width cut to suit pipe diameter for convenient spiral wrapping. The geo-tech fabric-wrapped pipe was allowed to cure overnight. Pipes were kept in a horizontal position. The drying area was well ventilated with controlled temperature and humidity levels at 30° C. and 50% RH. After 12 hours drying, a second layer of the composition of Example 1 or Example 2, preferably Example 2 was uniformly sprayed over the entire surface of the geo-tech fabric at an approximate rate of one (1) litre per square meter of the external surface area over the geo-tech fabric wrapping. The coated pipe was placed horizontally on stands above ground so that the web coated surfaces are not disturbed and allowed to cure for 24 hours under similar conditions as in the first drying step. The pipes were then ready for shipment. All the above procedures may be carried out either manually or for high output, using a mechanically automated system and robotic spraying mechanism.

The interior of the pipe may also be coated with the composition of Example 1 or Example 2 with or without reinforcing fabric material. The concept is also applicable to concrete pipes underground/overground in saline or other corrosive and concrete spalling conditions.

While the invention has been described in reference to specific embodiments it should be understood by those skilled in the art that various changes can be made and equivalents may be substituted without departing from the true spirit and scope of the invention. All such modifications are intended to be within the scope of the claims appended hereto.

The embodiments of the invention in which an exclusive property or privilege is claimed are as follows:

1. A method of protecting metal pipelines from the effects of a corrosive environment, the method comprising applying to the surface of the pipeline a thin layer of a vulcanizable elastomeric polyorganosiloxane rubber composition, applying geo-tech or similar fabric onto the wet surface; and allowing the vulcanizable elastomeric polyorganosiloxane rubber composition to cure to a silicone elastomer.

2. A method according to claim 1 including the additional step of applying a second thin layer of a vulcanizable elastomeric polyorganosiloxane rubber composition which may be the same or different as the first layer and allowing the vulcanizable elastomeric polyorganosiloxane rubber composition to cure.

3. A method according to claim 2 wherein each vulcanizable elastomeric polyorganosiloxane rubber composition comprises:
a) from about 5 to about 80 weight percent of one or more polyorganosiloxane fluids of the formula:
R¹[(R)₂SiO]n(R)₂Si R¹
in which R is a monovalent alkyl or alkenyl radical having 1 to 8 carbon atoms or a phenyl radical, which may contain 3 to 9 halogen atoms, R¹ each of which may be the same or different are OH, or a monovalent alkyl or alkenyl radical having 1 to 8 carbon atoms or a phenyl radical, and n has an average value such that the viscosity is from about 100 to about 100,000 centipoise at 25° C., in at least one of the polyorganosiloxane fluids R⁹ is a reactive group selected from OH and alkenyl;
b) from about 10 to about 80 weight percent of a sacrificial metal filler;
c) from about 0 to about 15 weight percent of a conductive filler;
d) a suitable catalyst for the reactive group of the polyorganosiloxane of (a); and
e) a suitable cross linking agent for the reactive group of the polyorganosiloxane of (a).

4. A method according to claim 3 wherein each vulcanizable elastomeric polyorganosiloxane rubber composition is a one part room temperature vulcanizable (RTV) polyorganosiloxane composition comprising:
a) about 5 to 60 weight percent of polydimethyl siloxane fluid of the formula:
HO[(R¹⁷)₂SiO]ₙ(R¹⁷)₂SiOH
in which R¹⁷ is a monovalent alkyl or alkenyl radical having 1 to 8 carbon atoms or a phenyl radical, which may contain 3 to 9 halogen atoms, and n has an average value such that the viscosity is from about 10 to about 100,000 centipoise at 25° C.;
b) about 0 to 80 weight percent of one or more fillers;
c) about 0.1 to 35 weight percent of one or more silane cross linkers or chain extenders;
d) about 0.2 to 3 weight percent of an adhesion promoter;
e) about 0.05 to 5 weight percent of a catalyst; and
f) about 0 to 40 weight percent of a suitable solvent or diluent as a dispersion medium for the above composition.

5. A method according to claim 4 wherein the composition includes about 20 to 50 weight percent of a mixture of amorphous and crystalline SiO₂ reinforcing fillers, the amorphous filler having a surface area of up to 200 m²/g and a specific gravity of 2.2.

6. A method according to claim 5 wherein the cross linking agent has the general formula:
(X)₄₋ₘ—Si—R²ₘ
where R¹² is an alkyl, alkenyl or phenyl radical (preferably methyl or ethyl), X is an alkyl radical with a functional group selected from carboxyl, ketoximino, alkoxy, carbonyl or amine linked directly to the silicone atom, and m is an integer of from 0 to 2.

7. A method according to claim 6 wherein the cross linking agent is an oximinosilane cross linking agent of the formula:
R²⁰Si(ON═CR²¹₂)₃
in which R²⁰ and R²¹ are independently selected from monovalent alkyl or alkenyl radicals having 1 to 8 carbon atoms or a phenyl radical which may optionally be substituted with an alkyl radical having 1 to 8 carbon atoms.

8. A method according to claim 7 wherein the adhesion promoter has the formula: 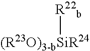
in which R²² and R²³ are independently selected from monovalent alkyl or alkenyl radicals having 1 to 8 carbon atoms or a phenyl radical which may optionally be substituted with an alkyl radical having 1 to 8 carbon atoms and may also contain 3 to 9 halogen atoms, b is an integer between 0 and 3, and R²⁴ is a saturated, unsaturated or aromatic hydrocarbon radical having 1 to 10 carbon atoms which may be further functionalized by a member selected from the group consisting of amino, ether, epoxy, isocyanate, cyano, acryloxy and acyloxy and combinations thereof.

9. A method according to claim 8 wherein the catalyst is of the formula:
(R²⁵)₂M(R²⁶)₂
where R²⁵ is monovalent alkyl or alkenyl radical having 1 to 10 carbon atoms or a phenyl radical, R²⁶ is an alkyl or alkenyl radical having 1 to 10 carbon atoms or a phenyl radical having an organo-functional group and M is a metal.

10. A method according to claim 9 wherein the catalyst is selected from the group consisting of dibutyltindiacetate, stannous octoate and dibutyltin dioctoate.

11. A method according to claim 10 wherein the composition includes from about 10 to about 80 weight percent of one or more sacrificial metal fillers selected from zinc powder, zinc flakes, aluminum powder, aluminum flakes, nickel powder, nickel flakes, magnesium powder, and magnesium flakes.

12. A method according to claim 11 wherein the sacrificial metal filler is zinc powder or zinc flakes.

13. A method according to claim 3 wherein the composition for the first layer comprises:
a) about 24 weight percent of a hydroxyl terminated dimethyl polysiloxane fluid having a viscosity of about 5,000 Centipoise at 25° C.;
b) about 2 weight percent of a mixture of amorphous and crystalline SiO₂ fillers having a specific gravity of 2.2 and surface area of up to about 130 m²/g;
c) about 3 weight percent of methyl tris-(methyl ethyl ketoxime)silane;
d) about 1 weight percent of N-(2 aminoethyl-3 aminopropyl)trimethoxysilane;
e) about 0.1 weight percent of dibutyltindilaurate;
f) about 50 weight percent of one or more sacrificial metal fillers selected from zinc powder, zinc flakes, aluminum powder, and aluminum flakes;
g) about 10 weight percent of metal coated glass fibres are a conductive filler; and
h) about 10 weight percent of a solvent.

14. A method according to claim 13 wherein the composition for the second layer comprises:
a) about 36 weight percent of a hydroxyl terminated dimethyl polysiloxane fluid having a viscosity of about 16,750 Centipoise at 25° C.;
b) about 35 weight percent of a mixture of amorphous and crystalline SiO₂ fillers having a specific gravity of 2.2 and surface area of up to about 130 m²/g;
c) about 3 weight percent of methyl tris-(methyl ethyl ketoxime)silane;
d) about 1 weight percent of N-(2 aminoethyl-3 aminopropyl)trimethoxysilane;
e) about 0.1 weight percent of dibutyltindilaurate;
f) about 2 weight percent of pigment; and
g) about 23 weight percent of a solvent.
